(19) United States
(12) Patent Application Publication
(10) Pub. No.: US 2019/0389294 A1
(43) Pub. Date: Dec. 26, 2019

(54) HAND-HELD MAGNETIC CLAMPING DEVICE FOR CAR COVERS

(71) Applicant: Ronald W. Brown, Cincinnati, OH (US)

(72) Inventor: Ronald W. Brown, Cincinnati, OH (US)

(21) Appl. No.: 16/564,764

(22) Filed: Sep. 9, 2019

Related U.S. Application Data
(63) Continuation-in-part of application No. 16/312,500, filed on Dec. 21, 2018.
(60) Provisional application No. 62/381,738, filed on Aug. 31, 2016.
(60) Provisional application No. 62/735,555, filed on Sep. 24, 2018.

(51) Int. Cl. B60J 11/06

(52) U.S. Cl. CPC B60J 11/06; B60R 13/04

(57) ABSTRACT

A hand-held magnetic clamping system for clamping a car cover onto the exterior surface of a vehicle includes an encasing structure, and a plurality of magnets. A first clamping device can clamp the cover onto the exterior surface or can sandwich the cover between a second clamping device that adheres to the exterior surface. The plurality of magnets magnetically affixes the encasing structure to the body's surface, thereby preventing the car cover from sliding off of the exterior body's surface. The second clamping device can include nano-suction adhesion material and/or suction cups. As a result, the first contact side of the encasing structure is used to clamp a thickly padded car cover while the second contact side of the encasing structure is used to clamp a thinly padded car cover. Further, the second clamping device can be used to attach the cover to a non-ferromagnetic surface.

### CROSS-REFERENCE TO RELATED APPLICATION

This application is a continuation-in-part under 35 U.S.C. § 120 based upon co-pending U.S. patent application Ser. No. 16/312,500 filed on Dec. 21, 2018, which is incorporated herein by reference in its entirety.

This application claims the benefit of priority under 35 U.S.C. § 119(e) based upon co-pending U.S. provisional patent application Ser. No. 62/735,555 filed on Sep. 24, 2018. The entire disclosure of the prior provisional application is incorporated herein by reference.

### BACKGROUND

### Technical Field

The present technology relates to a clamping system for covers for use in connection with a hand-held magnetic clamping device for clamping a car cover onto the exterior surface of a car. More specifically, the present clamping system can include at least two clamping devices each including a plurality of magnets secured within an encasing structure configured for mutual attraction to secure a cover therebetween, where one clamping device includes a non-magnetic adhering surface for attachment to a non-metallic, non-magnetic or non-ferromagnetic surface.

### Background Description

A hand held magnetic device aids in securing a car cover onto an automobile's steel exterior surface. Whereas, without said device, an individual would not be able to easily affix, position, and secure the cover due to the size of most car covers. This device is rectangular in shape with a soft resin exterior skin, which has corners and rounded edges designed to prevent damage to the exterior of any automobile's thin painted surface. The device contains a plurality of magnets dispersed throughout the interior of its encasement. The dispersed magnets are held individually and securely within an internal scaffolding. Clamping a thin material car cover does not require as much magnetic pull as clamping a thicker material car cover material onto an automobile. As such, the scaffolding is configured to reduce the magnetic attraction on one side and leave the magnetic attraction on an opposite side unaffected.

One side of the internal scaffolding is more open, thereby exposing the plurality of magnets held therein. The opposite side of the internal scaffolding is covered by an internal scaffolding skin, which is positioned between the plurality of magnets and the internal contact side of the encasing structure. The internal skin increases the distance between the external surface of the encasing skin and the plurality of magnets on that side thereby reducing the magnetic pull. Because of this design, the magnetic pull at one side is stronger than the magnetic pull at the opposite side. A reversible handle is secured to the encasing structure via an attachment bar, which allows either side to have a handle during use.

However, some automobiles include exterior surfaces that are made from non-metallic or non-ferromagnetic materials, thereby making the attraction of a magnetic clamping device difficult or impossible. Suction cups have been utilized for securing objects to the exterior surface of automobiles, however these devices normally utilize protruding suction cups with exposed metal hook-like appendages.

Therefore, a need exists for a new and novel clamping device for car covers that can be used for clamping a car cover onto a non-metallic, non-magnetic or non-ferromagnetic exterior surface of a car. In this regard, the present technology substantially fulfills this need. In this respect, the clamping device for car covers according to the present technology substantially departs from the conventional concepts and designs of the prior art, and in doing so provides an apparatus primarily developed for the purpose of clamping a car cover onto the exterior surface of a car.

### BRIEF SUMMARY OF THE PRESENT TECHNOLOGY

In view of the foregoing disadvantages inherent in the known types of car cover holders now present in the prior art, the present technology provides a novel clamping device for car covers, and overcomes the above-mentioned disadvantages and drawbacks of the prior art. As such, the general purpose of the present technology, which will be described subsequently in greater detail, is to provide a new and novel clamping device for car covers and method which has all the advantages of the prior art mentioned heretofore and many novel features that result in a clamping device for car covers which is not anticipated, rendered obvious, suggested, or even implied by the prior art, either alone or in any combination thereof.

According to one aspect of the present technology, the present technology can include a clamping system for covers comprising a cover clamp including one or more encasing structures providing a first contact side and a second contact side. The first contact side and the second contact side can be positioned opposite to each other about the one or more encasing structures. The first contact side or the second contact side can be configured to be in juxtaposition with a cover. A nano-suction section can be associated with at least one of the first contact side, and the second contact side. The nano-suction section can be configured or configurable to adhere to a ferromagnetic surface or a non-ferromagnetic surface. A plurality of magnets can be mountable within the one or more encasing structures and distributed throughout the one or more encasing structures. The plurality of magnets can be operatively integrated into the one or more encasing structures to be magnetically attractable to a second magnet or the ferromagnetic surface.

According to another aspect of the present technology, the present technology can include a clamping system for covers comprising a first cover clamp and a second cover clamp, each comprising one or more encasing structures providing a first contact side and a second contact side, and a plurality of magnets. The first contact side and the second contact side can be positioned opposite to each other about the one or more encasing structures. The plurality of magnets can be mountable within the one or more encasing structures and distributed throughout the one or more encasing structures, respectively. The plurality of magnets can be operatively integrated into the one or more encasing structures, respectively. A nano-suction section can be associated with the second contact side of the first cover clamp, and the nano-suction section can be configured or configurable to adhere to a surface. The plurality of magnets can be orientated in the second cover clamp to magnetically coupled with the plurality of magnets of the first cover clamp when the second contact side of the second cover clamp is adjacent the first contact side of the first cover clamp. The first cover clamp and the second cover clamp can be configured to clamp a cover or a portion thereof positioned therebetween when the first cover clamp and the second cover clamp are magnetically coupled to each other.

According to yet another aspect of the present technology, the present technology can include a method of using a clamping system to hold a cover in relation to a surface. The method comprising the steps of applying a nano-suction section associated with a second contact side of a first cover clamp to a surface. Positioning a portion of a cover over the first cover clamp. Positioning a second cover clamp adjacent the first cover clamp so that the cover or a portion thereof is therebetween and a plurality of magnets of the first cover clamp and a plurality of magnets of the second cover clamp are magnetically attracted to each other.

In some embodiments, the one or more encasing structures can be at least two encasing structures joined together.

In some embodiments, the plurality of magnets can be configured to generate a stronger magnetic pull across the first contact side and a weaker magnetic pull across the second contact side.

Embodiments of the present technology can include a handle being detachably attached adjacent to the one or more encasing structures.

In some embodiments, the one or more encasing structures comprises a first planar side, a second planar side, and a plurality of recesses, wherein the first planar side and the second planar side are two distinctly different sides; each of the plurality of recesses traversing through the first planar side towards the second planar side; and the plurality of recesses being distributed across the first planar side; each of the plurality of magnets being mounted into a corresponding recess from the plurality of recesses.

Embodiment of the present technology can include a second cover clamp including one or more encasing structures providing a first contact side and a second contact side, and a plurality of magnets mountable within the one or more encasing structures of the second cover clamp.

In some embodiments, the plurality of magnets of the cover clamp being orientated so that a magnetic attraction is created when the second contact side of the cover clamp is adjacent the first contact side of the second cover clamp.

In some embodiments, the cover clamp and the second cover clamp are configured to clamp a cover or a portion thereof positioned therebetween when the cover clamp and the second cover clamp are magnetically coupled to each other.

Embodiment of the present technology can include a suction cup associated with the second contact side and in combination with the nano-suction section.

In some embodiments, the nano-suction section is a nano-suction material integrated with or attached to the second contact side.

In some embodiments, the one or more encasing structures are made of a soft resin.

In some embodiments, the one or more encasing structures comprises a plurality of rounded corners and a plurality of rounded edges; and the plurality of rounded corners and the plurality of rounded edges being externally distributed about the one or more encasing structures.

In some embodiments, the second cover clamp does not include a nano-suction section.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide a new and novel clamping device or system for car covers that has all of the advantages of the prior art cover holders and none of the disadvantages.

It is another object of the present technology to provide a new and novel clamping device or system for car covers that may be easily and efficiently manufactured and marketed.

An even further object of the present technology is to provide a new and novel clamping device or system for car covers that has a low cost of manufacture with regard to both materials and labor, and which accordingly is then susceptible of low prices of sale to the consuming public, thereby making such clamping device for car covers economically available to the buying public.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

The present technology will be better understood and objects other than those set forth above will become apparent when consideration is given to the following detailed description thereof. Such description makes reference to the annexed drawings, where the phantom lines may depict environmental structure, wherein:

FIG. 1 is a perspective view of the present technology with the second contact side being positioned face-up.

FIG. 2 is a perspective view of the present technology with the first contact side being positioned face-up.

FIG. 3 is a perspective view of the present technology with the first contact side being positioned face-up, wherein a portion of the encasing structure is removed to reveal the scaffolding on the inside.

FIG. 4 is a perspective view of the present technology taken along line 4-4 in FIG. 2, wherein the position of the magnets is shown in relation to the first contact side and the second contact side.

FIG. 5 is an exploded view of the plurality of magnets and the scaffolding, wherein the scaffolding includes the snap-locking upper lip.

FIG. 6 is an exploded view of the plurality of magnets and the scaffolding, wherein the scaffolding includes the snap-locking upper tabs.

FIG. 7 is a perspective view of the scaffolding with the second planar side being positioned face-up.

FIG. 8 is a perspective view of the present technology with the reversible handle being positioned across the first contact side.

FIG. 9 is a perspective view of the car cover clamping system of the present technology with the second contact side of the first and second clamping devices being positioned face-up.

FIG. 10 is an exploded perspective view of the second clamping device with the first contact side being in view.

FIG. 11 is cross-sectional view of the second clamping device taken along line 11-11 in FIG. 9.

FIG. 12 is a side plane view of the car cover clamping system in use with the cover clamped between the first and second clamping device, and the second clamping device attached to the exterior surface of the vehicle.

FIG. 13 is an exploded perspective view of an alternate second clamping device with the first contact side being in view and featuring suction cups.

FIG. 14 is an internal perspective view of a cover clamp of the present technology.

FIG. 15 is an internal perspective view of the segments within holes and chambers.

FIG. 16 is a top view of the segments of the present technology.

FIG. 17 is a perspective view of the segments of the present technology.

FIG. 18 is a side perspective view of the entry holes of the present technology.

FIG. 19 is a perspective view of the present technology in an exemplary use with a portion of the cover clamped between the first and second clamping devices that are offset coupled and bent.

The same reference numerals refer to the same parts throughout the various figures.

### DETAILED DESCRIPTION OF THE PRESENT TECHNOLOGY

All illustrations of the drawings are for the purpose of describing selected versions of the present technology and are not intended to limit the scope of the present technology.

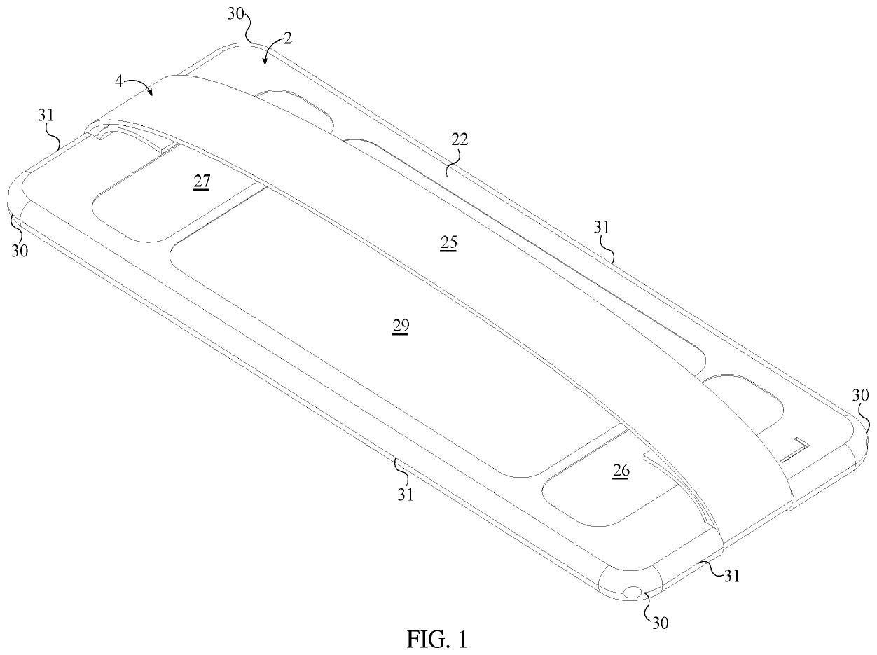

The present technology is a magnetic clamping device for car covers capable of magnetically securing a car cover onto the metallic exterior surface of a car's body. An embodiment of the present technology comprises a plurality of magnets 1, an encasing structure 2, a reversible handle 4, and a scaffolding 5. Conventional automobiles utilize an exterior body made of metallic materials that are magnetically conductive. This allows the plurality of magnets 1 to magnetically fasten the encasing structure 2 to the exterior body surface of an automobile with a car cover in-between. In reference to FIG. 1, the plurality of magnets 1 generates a magnetic field that interacts with the metallic materials in the exterior body. The reversible handle 4 can be used to physically pull the encasing structure 2 apart from the car cover and the exterior body surface. The encasing structure 2 comprises a first contact side 21 and a second contact side 22. The magnetic attraction between the plurality of magnets 1 and the exterior body surface causes either the first contact side 21 or the second contact side 22 to press against the car cover. This allows the encasing structure 2 to clamp the car cover onto the exterior body surface.

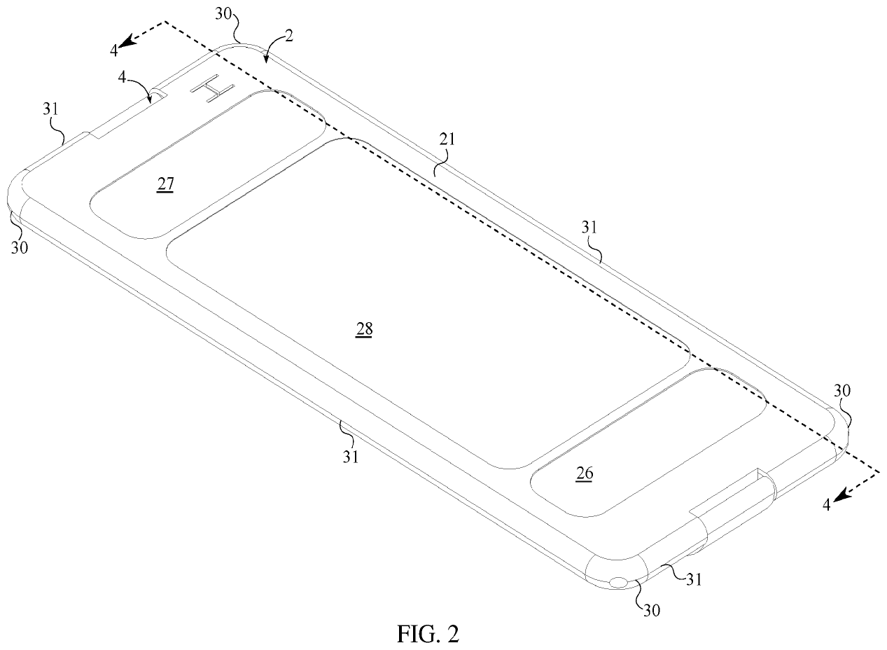

Referring to FIG. 1 and FIG. 2, the first contact side 21 and the second contact side 22 are positioned opposite to each other about the encasing structure 2. The plurality of magnets 1 is mounted within the encasing structure 2 by the scaffolding 5. In particular, the scaffolding 5 securely positions the plurality of magnets 1 throughout the encasing structure 2. As a result, the plurality of magnets 1 is distributed throughout the encasing structure 2. The magnetic force generated by the plurality of magnets 1 is distributed equally about the encasing structure 2. This prevents the creation of pressure points, which can damage the underlying exterior body surface. The plurality of magnets 1 is operatively integrated into the encasing structure 2, wherein the plurality of magnets 1 generates a stronger magnetic pull across the first contact side 21 and a weaker magnetic pull across the second contact side 22. In the preferred implementation of the present technology, the second contact side 22 with the weaker magnetic pull may be used to clamp a car cover with shallow thickness, while the first contact side 21 may be used to clamp a thicker car cover. The reversible handle 4 is detachably attached to the encasing structure 2. In particular, the first end of the reversible handle 4 is attached adjacently to the first end of the encasing structure 2 and the second end of the reversible handle 4 is detachably attached to the second end of the encasing structure 2. The user can grip the reversible handle 4 by holding on to the concave side of the reversible handle 4.

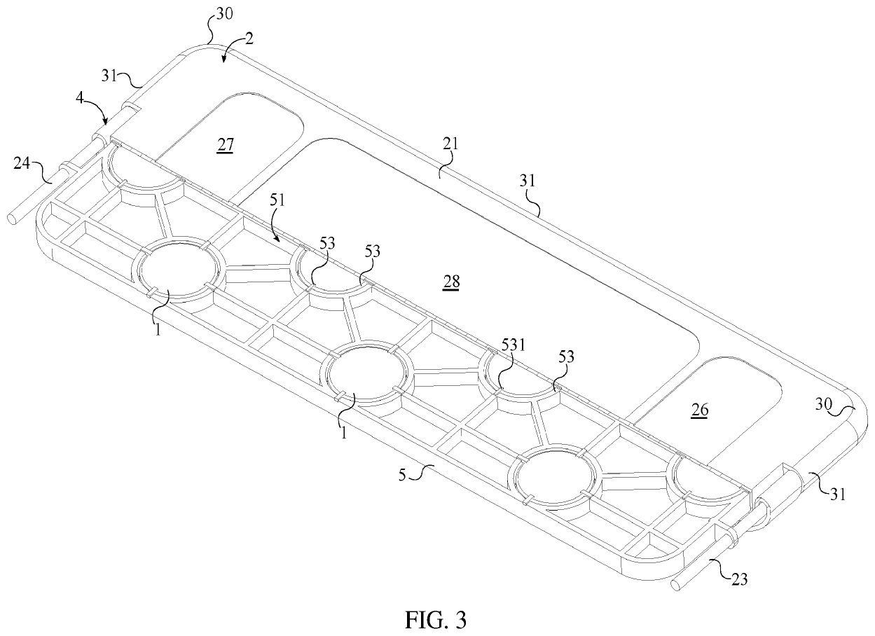

As is apparent in FIG. 3, the plurality of magnets 1 is placed within a scaffolding 5 that prevents ghost silhouetting on the outer surface of the encasing structure 2. Accordingly, the scaffolding 5 comprises a first planar side 51, a second planar side 52, and a plurality of slots 53, wherein the first planar side 51 and the second planar side 52 are two distinctly different sides. In the preferred implementation of the present technology, the plurality of magnets 1 lies on top of the second planar side 52. The second planar side 52 is configured to reduce the magnetic pull of the plurality of magnets 1 at the second contact side 22, in relation to the magnetic pull at the first contact side 21. As such, the magnetic pull at the first planar side 51 and, thus, the first contact side 21 is greater than the magnetic pull at the second contact side 22. The first planar side 51 presents an opening whereby the plurality of magnets 1 are inserted into the scaffolding 5. Each of the plurality of slots 53 is connected to each other via connective pieces. The connective pieces fix the vertical and horizontal distance between each of the plurality of slots 53. Each of the plurality of magnets 1 is mounted into a corresponding slot from the plurality of slots 53. As such, the plurality of slots 53 is used to physically separate each of the plurality of magnets 1 from each other. In addition to securing the plurality of magnets 1 in the desired position, the scaffolding 5 also adds rigidity and structural integrity to the encasing structure 2. Accordingly, the scaffolding 5 is mounted within the encasing structure 2.

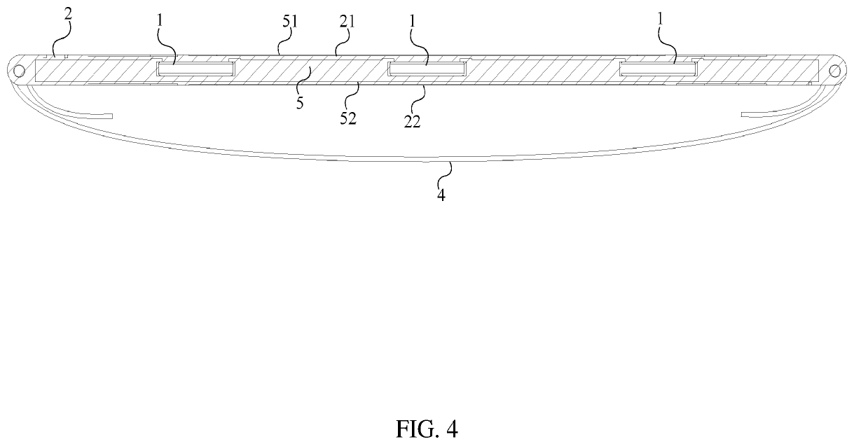

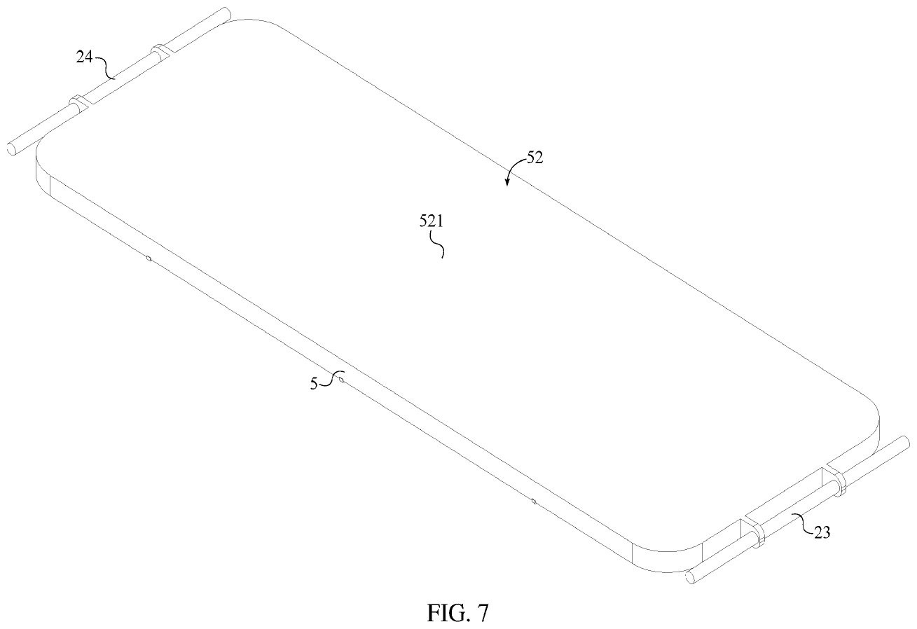

Referring now to FIG. 7, in the preferred embodiment of the present technology, the second planar side 52 is an integrated floor panel 521. Referring to FIG. 4, the integrated floor panel 521 is positioned between the scaffolding 5 and the interior of the second contact side 22. The integrated floor panel 521 is made of high-density polymers which allows the scaffolding 5 to flex while retaining the original shape. The integrated floor panel 521 increases the effective distance between the plurality of magnets 1 and the second contact side 22 of the encasing structure 2, thereby moving the plurality of magnets 1 closer to the first contact side 21. As a result, the plurality of magnets 1 is positioned closer to the first contact side 21 than the second contact side 22, which causes the magnetic attraction at the first contact side 21 to be stronger than the magnetic attraction at the second contact side 22. Accordingly, the attraction force exerted by the first contact side 21 on the exterior body surface is significantly higher than attraction force exerted by the second contact side 22. As such, a thickly padded car cover may be used to cushion the exterior body surface against the first contact side 21. Accordingly, in the preferred implementation of the present technology, the first contact side 21 with the relatively strong magnetic pull is used to securely clamp a very thickly padded car cover. The second contact side 22 having a relatively weak magnetic pull is used to clamp a thinly padded car cover.

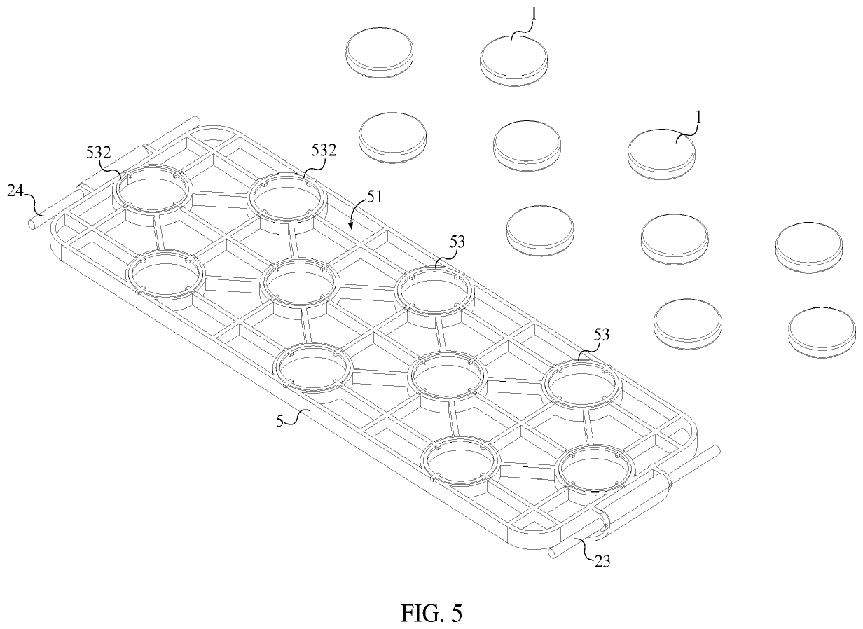

In reference to FIG. 5, each of the plurality of slots 53 comprises a snap-locking upper lip 531. The snap-locking upper lip 531 mechanically fastens each of the plurality of magnets 1 inside a corresponding slot and thus is positioned within an opening of the corresponding slot. More specifically, the snap-locking upper lip 531 protrudes inwards from the opening on each of the plurality of slots 53. Each of the plurality of magnets 1 is pressed and held within the corresponding slot by the snap-locking upper lip 531, wherein the plurality of magnets 1 is prevented from being pushed out by the integrated floor panel 521. In order to insert one of the plurality of magnets 1 into one of the plurality of slots 53, the opening is enlarged by bending the snap-locking upper lip 531. Once inserted, the snap-locking upper lip 531 bends back into the straight position reducing the size of the opening and locking one of the plurality of magnets 1 therein.

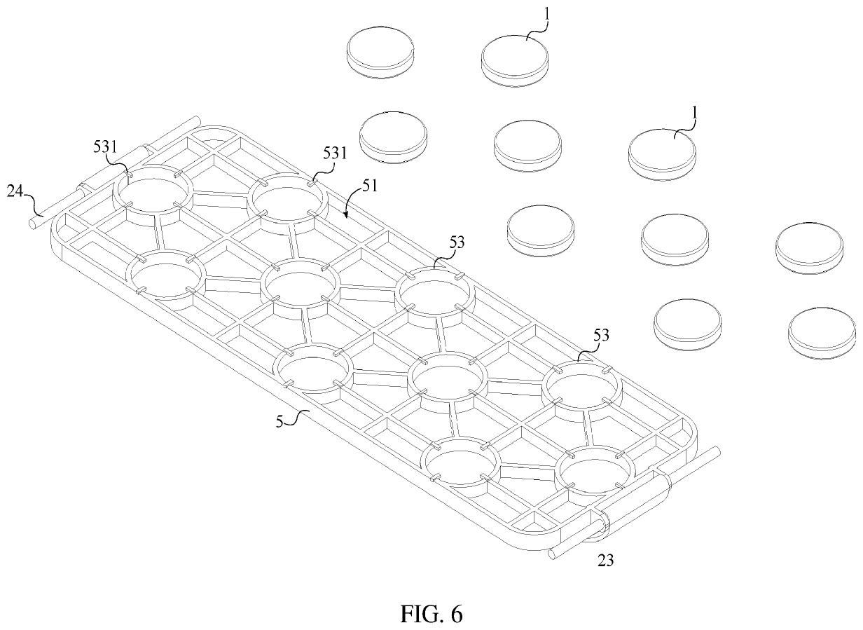

In an alternate embodiment of the present technology, each of the plurality of slots 53 comprises a plurality of snap-locking upper tabs 532. As can be seen in FIG. 6, the plurality of snap-locking upper tabs 532 is distributed about an opening of the corresponding slot. More specifically, each snap-locking upper tab 532 is radially equidistant from one another. Each of the plurality of magnets 1 is pressed and held within the corresponding slot by the plurality of snap-locking upper tabs 532, wherein the plurality of magnets 1 is prevented from being pushed out by the integrated floor panel 521. The plurality of snap-locking upper tabs 532 is deformable in one direction. This allows for the insertion of the plurality of magnets 1 into the plurality of slots 53, while preventing each the plurality of magnets 1 from pulling out from the corresponding slot due to the magnetic force.

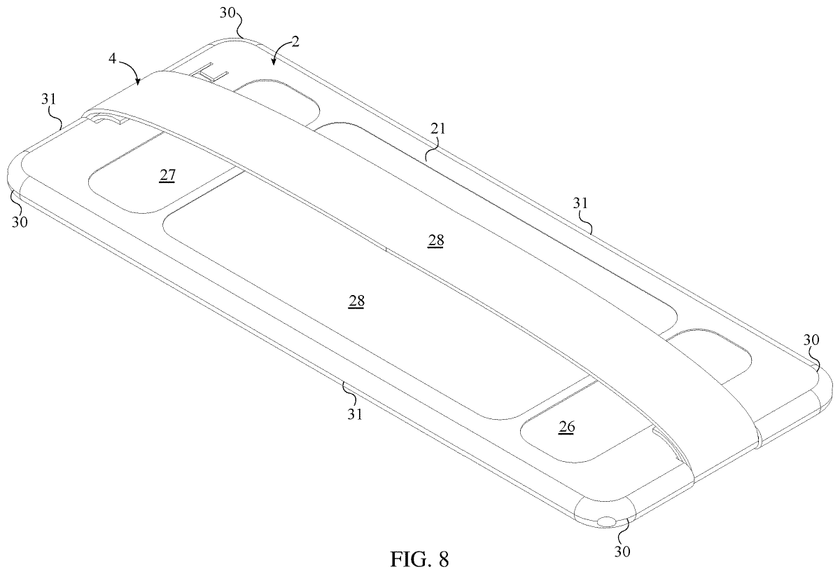

The preferred embodiment of the reversible handle 4 is detachably attached to the encasing structure 2. As is apparent in FIG. 1 and FIG. 8, this allows the user to switch the position of the reversible handle 4 in relation to the encasing structure 2. As such, the reversible handle 4 is positioned across the first contact side 21. This configuration allows the user access to the reversible handle 4 when the second contact side 22 is used to clamp the car cover. Alternately, the reversible handle 4 is positioned across the second contact side 22. This configuration allows the user access to the reversible handle 4 when the first contact side 21 is used to clamp the car cover.

Referring once more to FIG. 5 and FIG. 6, the encasing structure 2 comprises a first handle-attachment bar 23 and a second handle-attachment bar 24. The first handle-attachment bar 23 and the second handle-attachment bar 24 selectively couples the reversible handle 4 to the encasing structure 2. A couple of holes positioned on the opposite ends of the encasing structure allows the first handle-attachment bar 23 and the second handle-attachment bar 24 to be mounted inside the encasing structure 2. The couple of holes are positioned concentric to the handle receiving holes positioned on the opposite ends of the scaffolding 5. As such, the couple of holes allow the first handle-attachment bar 23 and the second handle-attachment bar 24 can connect to the handle receiving holes of the scaffolding. This also enables the user to replace the first handle-attachment bar 23 and the second handle-attachment bar 24 as needed. Both the first handle-attachment bar 23 and the second handle-attachment bar 24 utilize a metallic bar pivotally coupled to the terminal portions of the reversible handle 4. Alternately, the first handle-attachment bar 23 and the second handle-attachment bar 24 may be coupled via any other suitable mechanism. The first handle-attachment bar 23 is terminally mounted to the encasing structure 2. In particular, the first handle-attachment bar 23 is mounted onto a first slot cut into the distal portion of the encasing structure 2. Further, the second handle-attachment bar 24 is terminally mounted to the encasing structure 2, opposite to the first handle-attachment bar 23. In particular, the second handle-attachment bar 24 is mounted to a second slot cut into the distal portion of the encasing structure 2, opposite the first slot. The first handle-attachment bar 23 and the second handle-attachment bar 24 are positioned in between the first contact side 21 and the second contact side 22. As such, the reversible handle 4 is attached in the middle portion of the encasing structure 2. When the user pulls the reversible handle 4, this configuration causes tension exerted on the reversible handle 4 to be distributed equally between the first handle-attachment bar 23 and the second handle-attachment bar 24.

Referring once more to FIG. 1 and FIG. 2, the preferred embodiment of the reversible handle 4 comprises a single continuous strap 25. More specifically, hooks-and-loops fasteners mounted on the lateral surfaces of the single continuous strap 25 allows the reversible handle 4 to releasably couple to the encasing structure 2. This allows the user to change the position of the reversible handle 4 in relation to the encasing structure 2. As a result, the concave side of the reversible handle 4 can be positioned adjacent to either the first contact side 21 or the second contact side 22. Thus, when the first contact side 21 is utilized on a car cover, the concave side of the reversible handle 4 is positioned adjacent the second contact side 22, in easy reach of the user. When the second contact side 22 is utilized on a car cover, the concave side of the reversible handle 4 is positioned adjacent the first contact side 21, allowing the user to grip thereon. The first handle-attachment bar 23 is terminally coupled to the single continuous strap 25. The second handle-attachment bar 24 is terminally coupled to the single continuous strap 25, opposite to the first handle-attachment bar 23. The terminal portions of the single continuous strap 25 are looped around the first handle-attachment bar 23 and the second handle-attachment bar 24. The hooks-and-loops fastener is used to securely close the loops on their respective terminal portions. In order to release the reversible handle 4, the hooks-and-loops fastener is disconnected and the terminal portions are untied from the first handle-attachment bar 23 and the second handle-attachment bar 24.

In another embodiment of the present technology, the reversible handle 4 comprises a first strap and a second strap. In the preferred implementation of the present technology, the user can grip the first strap and the second strap to physically pull the encasing structure 2 off of the exterior body surface. As such, the first handle-attachment bar 23 is terminally coupled to the first strap. Further, the second handle-attachment bar 24 is terminally coupled to the second strap. In the preferred implementation, the terminal portions of the first strap and the second strap are respectively looped around the first handle-attachment bar 23 and the second handle-attachment bar 24. Once tied, the terminal portions are secured using a selectively fastening mechanism. Alternately, the terminal portions may be secured via snaps, zippers, magnetic fasteners, and the similar mechanisms. Unlike the single continuous strap 25, the first strap and the second strap are accessible to the user regardless of the which of the first contact side 21 or second contact side 22 is utilized. Thus, the user does not need to change the position of the reversible handle 4 to switch from utilizing the first contact side 21 to the second contact side 22.

In reference to FIG. 6 and FIG. 7, the encasing structure 2 comprises a first cover-fastening mechanism 26 and a second cover-fastening mechanism 27. The first cover-fastening mechanism 26 and the second cover-fastening mechanism 27 allows the encasing structure 2 to be mounted onto a car cover. As such, the first cover-fastening mechanism 26 and the second cover-fastening mechanism 27 are integrated into the first contact side 21. Additionally, the first cover-fastening mechanism 26 and the second cover-fastening mechanism 27 are positioned opposite to each other across the first contact side 21. In the preferred implementation of the present technology, the first cover-fastening mechanism 26 and the second cover-fastening mechanism 27 are fashioned with the hook portions of a hooks-and-loops fastener. The hook portions selectively fasten to the loop portions integrated into the outer surface of the car cover, thereby allowing the encasing structure 2 to be temporarily mounted onto the outer surface of the car cover. This allows the present technology to be stored with the car cover when not in use.

In reference to FIG. 8, a first graphic-mounting recess 28 allows some decorative indicia to be displayed on top of the first contact side 21. The first graphic-mounting recess 28 traverses into the encasing structure 2 from the first contact side 21. Additionally, the first graphic-mounting recess 28 is centrally positioned in between the first cover-fastening mechanism 26 and the second cover-fastening mechanism 27. A sticker having some decorative indicia applied thereon is perimetrically mounted within the second graphic-mounting recess 29. In the preferred embodiment of the present technology, the recess perimetrically secures a sticker with the decorative indicia applied thereon. Alternately, the first graphic-mounting recess 28 can accommodate various different types of decorative indicia such as etchings, engravings, paintings, logos and the like.

In another embodiment of the present technology, the first cover-fastening mechanism 26 and the second cover-fastening mechanism 27 are integrated into the second contact side 22. Additionally, the first cover-fastening mechanism 26 and the second cover-fastening mechanism 27 are positioned opposite to each other across the second contact side 22. This allows the present technology to be mounted in a manner, which places the second contact side 22 coincident to the outer surface of the car cover.

As such, a second graphic-mounting recess 29 allows decorative indicia to be displayed on the encasing structure 2. As is apparent in FIG. 1, the second graphic-mounting recess 29 traverses into the encasing structure 2 from the second contact side 22. Additionally, the second graphic-mounting recess 29 is centrally positioned in between the first cover-fastening mechanism 26 and the second cover-fastening mechanism 27. As a result, the second graphic-mounting recess 29 positions the decorative indicia in a clearly visible area, when the first contact side 21 is used to clamp the car cover.

In some embodiments of the present technology, the encasing structure 2 is made of a soft resin. As is apparent in FIG. 1, the soft resin has a high coefficient of friction, which prevents the car cover from sliding away from the encasing structure 2. Additionally, the encasing structure 2 comprises a plurality of rounded corners 30 and a plurality of rounded edges 31. The plurality of rounded corners 30 and the plurality of rounded edges 31 are externally distributed about the encasing structure 2. The plurality of rounded corners 30 prevents the encasing structure 2 form scratching the painted exterior surface of the car if the encasing structure 2 starts sliding on top of the exterior body surface.

Although the technology has been explained in relation to its preferred embodiment, it is to be understood that many other possible modifications and variations can be made without departing from the spirit and scope of the technology as hereinafter claimed.

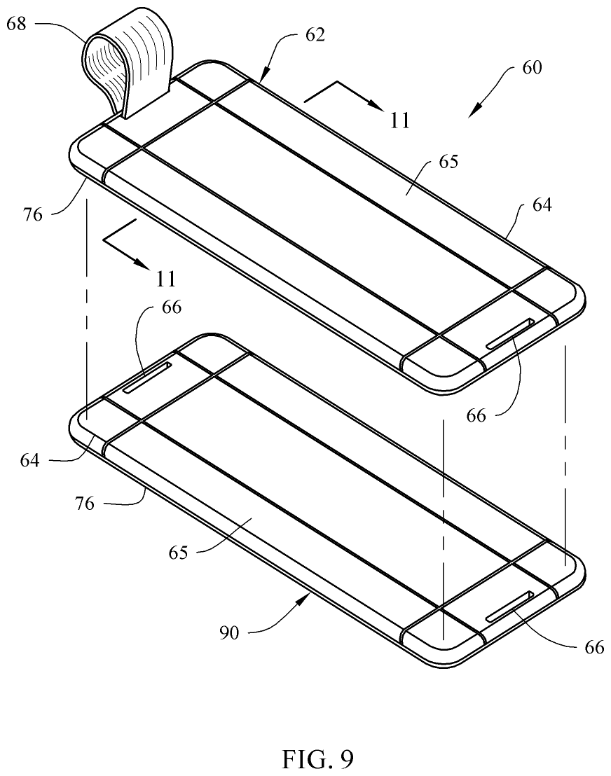

Referring to FIGS. 9-12, an embodiment of a cover clamp system 60 of the present technology for clamping a cover onto an exterior surface is illustrated and will be described. An embodiment of the present technology can comprise a first cover clamp 62 and a second cover clamp 90 utilized together to secure a cover to a surface, such as but not limited to a ferromagnetic or non-ferromagnetic surface of a vehicle. Each cover clamp 62, 90 can comprise a first encasing structure 64 and a second encasing structure 76 that are coupled or joined together to form the cover clamp, respectively. The first and second encasing structures 64, 76 can define one or more openings 66, 78, respectively, which can be configured to receive a handle 68 or mounting strap.

The handle 68 can comprise a single continuous strap or can be a loop, and can include hooks-and-loops fasteners mounted on lateral surfaces allowing the handle 68 to releasably couple to the encasing structures 64, 76. This allows the user to change the position of the handle 68 in relation to ends of the cover clamp 62, 90. The hooks-and-loops fastener can be used to securely close the handle 68 on their respective terminal portions. In order to release the handle 68, the hooks-and-loops fastener can be disconnected and the terminal portions are removed from the openings 66, 78 of the first and second enclosing structures 64, 76.

In another embodiment of the present technology, the handle 68 can comprise a first strap attached to the openings 66, 78 at a first end of the cover clamp 62, 90 and a second strap attached to the openings 66, 78 at a second end of the cover clamp 62, 90, with the first and second straps attachable to each other. The user can grip the attached first and second straps to physically pull the cover clamp 62, 90 off of the exterior body surface.

It can be appreciated that the strap 68 can be accessible to the user regardless of the which of the first contact side 65 or second contact side 80 is utilized. Thus, the user does not need to change the position of the handle 68 to switch from utilizing the first contact side 65 to the second contact side 80.

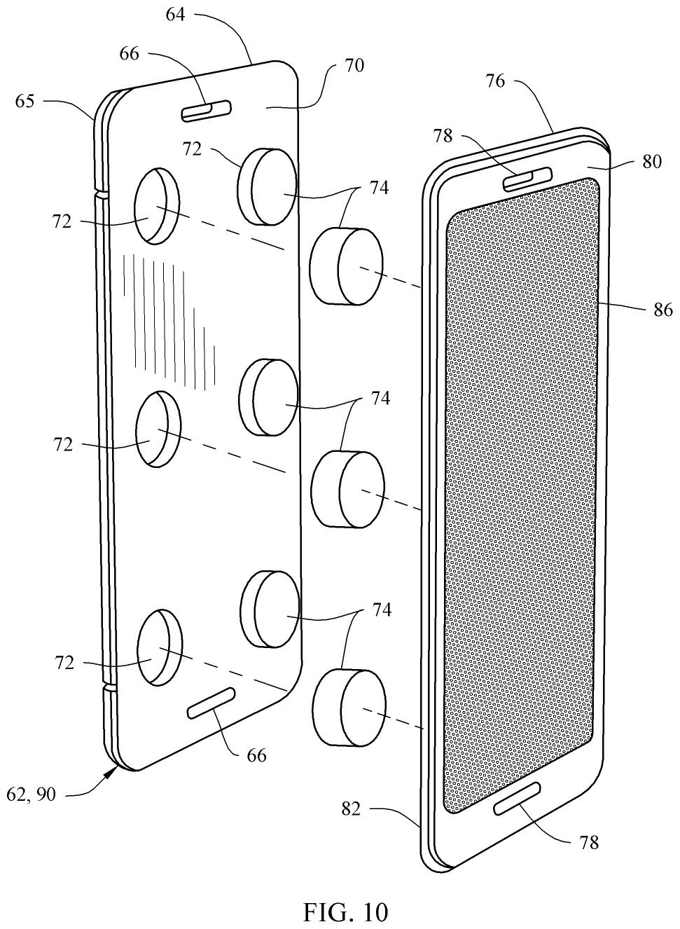

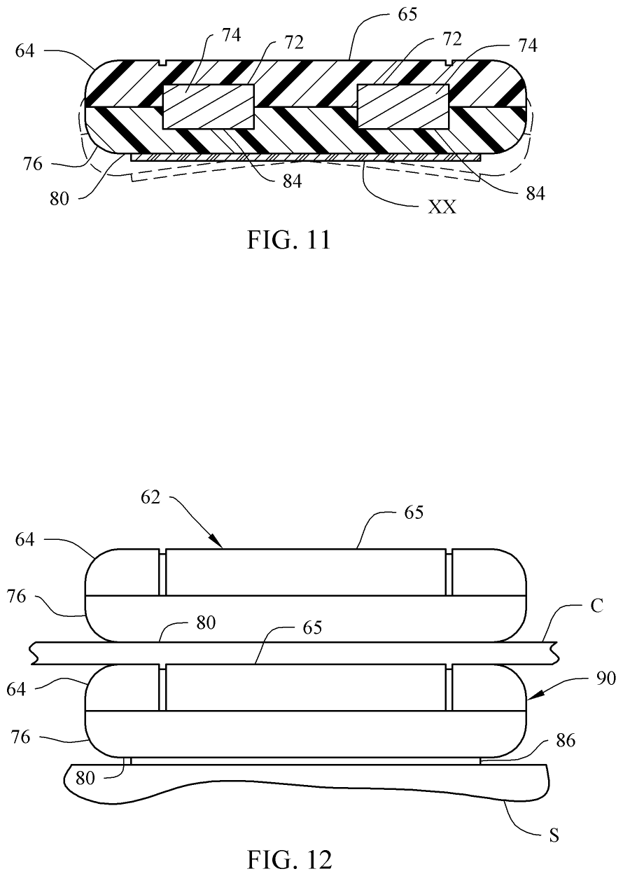

As illustrated in FIGS. 10 and 11, the first encasing structure 64 can comprise a first contact side 65 and an interior side 70. The first contact side 65 can include grooves, texturing, indicia or patterns, and can be substantially planar. The interior side 70 can include a plurality of recesses 72 defined therein, each configured to receive at least a portion of a magnet 74.

The second encasing structure 76 can comprise a second contact side 80 and an interior side 82. The second contact side 80 can include a substantially planar section. The interior side 82 can include a plurality of recesses 84 defined therein, each configured to receive at least a portion of the magnet 74, respectively. The recesses 72, 84 of the first and second encasing structures 64, 76 are arranged so that they are aligned with each other when the first and second encasing structures 64, 76 are joined, thereby securing one of the magnets 74 in each of recesses 72, 84.

It can be appreciated that the first contact side 65 and/or the second contact side 80 can include a first portion of a hooks-and-loops fastener. The first portion selectively fastenable to the second portion associated with an outer surface of the car cover, thereby allowing the cover clamp 62, 90 to be temporarily mounted onto the outer surface of the car cover. This allows the present technology to be stored with the car cover when not in use.

It can be further appreciated that the first contact side 65 can include one or more graphic-mounting recesses allowing some decorative indicia to be displayed on top of the first contact side 65. The graphic-mounting recesses can accommodate various different types of decorative indicia such as etchings, engravings, paintings, logos, sticker, emblems and the like.

The plurality of magnets 74 can be distributed throughout the cover clamp 62, 90. The magnetic force generated by the plurality of magnets 74 can be distributed equally about the cover clamp 62, 90. This prevents the creation of pressure points, which can damage any underlying exterior surface. The plurality of magnets 74 can be operatively integrated into the encasing structures 64, 76, wherein the plurality of magnets 74 can generate a stronger magnetic pull across the first contact side 65 and a weaker magnetic pull across the second contact side 80. It can be appreciated that the second contact side 80 with the weaker magnetic pull may be used to clamp a cover with shallow thickness, while the first contact side 65 may be used to clamp a thicker cover.

The second contact side 80 of either the first cover clamp 62 and/or the second cover clamp 90 can include a suction/adhesion section 86 configured or having the capability to suction or adhere to a surface, such as but not limited to a non-ferromagnetic surface. The suction/adhesion section 86 can be a nano-suction, nano-adhesion, micro-suction or micro-adhesion material attached to or integrated with the second contact side 80. In the exemplary, the nano-suction section 86 is a nano-suction tape adhesively attached to the second contact side 80. It can be appreciated that the nano-suction material 86 can utilize vacuum, negative fluid pressure and thousands or millions of nano-sized suction cups to securely adhere the cover clamp to a flat non-porous surface. When the nano-suction object is pressed against a flat surface S, as best illustrated in FIG. 12, thousands or millions of miniature suction cups create a large vacuum, generating a strong suction force that can hold the cover clamp 62, 90 to the surface S. The nature of the nano-suction technology allows easy removal without residue, and makes it reusable. The nano-suction material 86 can offer a favorable horizontal force to prevent the cover clamp 62, 90 from moving side to side along the surface S when attached thereto. However, the nano-suction material 86 can be configured to not prevent vertical forces from disconnecting the cover clamp 62, 90 from the surface S.

In an exemplary operational embodiment, only one of the cover clamps 62, 90 of the clamp system 60 may be used to secure the cover C to a metallic or ferromagnetic surface S. In some instances, conventional automobiles utilize an exterior body made of metallic materials that are magnetically conductive. This allows the plurality of magnets 74 to magnetically fasten the first and/or second encasing structure 64, 76 of either the first or second cover clamp 62, 90 to the exterior body surface of, but not limited to, an automobile with a car cover or a portion thereof in-between. The plurality of magnets 74 generates a magnetic field that interacts with the metallic materials in the exterior body. The handle 68 can be used to physically pull the cover clamp 62, 90 apart from each other, the car cover C and/or the exterior body surface S. The magnetic attraction between the plurality of magnets 74 and the exterior body surface S causes either the first contact side 65 or the second contact side 80 to press against the car cover C. This allows the cover clamp 62, 90 to clamp the car cover C onto the exterior body surface S.

In another exemplary use, as best illustrated in FIG. 12, the clamp system 60 can be utilized to clamp a cover C to a surface S, wherein the surface S can be a non-ferromagnetic or ferromagnetic surface, such a but not limited to, an exterior surface of a vehicle. In this exemplary use, one or more of the second cover clamps 90 that includes the nano-suction section 86 can be attached to a non-ferromagnetic surface S of a vehicle so that the first contact side 65 of the second clamp 90 is exposed. The nano-suction section 86 can be pressed against the surface S so that a sufficient suction or adhesion force is created, thereby securing the second cover clamps 90 to the surface S. The cover C can be positioned over the second cover clamp 90 and the surface S, after which one or more of the first cover clamps 62 can be placed on top of the cover C and over a respective second cover clamp 90, so that the magnets 74 of the first and second cover clamps 62, 90 are magnetically attracted together, thereby clamping the cover C or a portion thereof therebetween. It can be appreciated that the cover C can be clamped between the first and second cover clamps 62, 90 prior to the second cover clamp 90 being adhered to the surface S.

It can be appreciated that the nano-suction section 86 can be utilized with the first contact side 21 and/or the second contact side 22 of the encasing structure 2 of the embodiment shown in FIGS. 1-8. It can further be appreciated that the scaffolding 5 of the embodiment shown in FIGS. 1-8 can be utilized with the first cover clamp 62 and/or the second cover clamp 90.

To remove the cover C, a user can grasp the handle 68 of the first cover clamp 62 and pull or slide the first cover clamp 62 away from its magnetically coupled second cover clamp 90, thereby removing the clamping force against the cover C. The cover C can then be removed from the surface S, and the user can then grasp the handle 68 of the second cover clamp 90 and pull or slide it from the surface S.

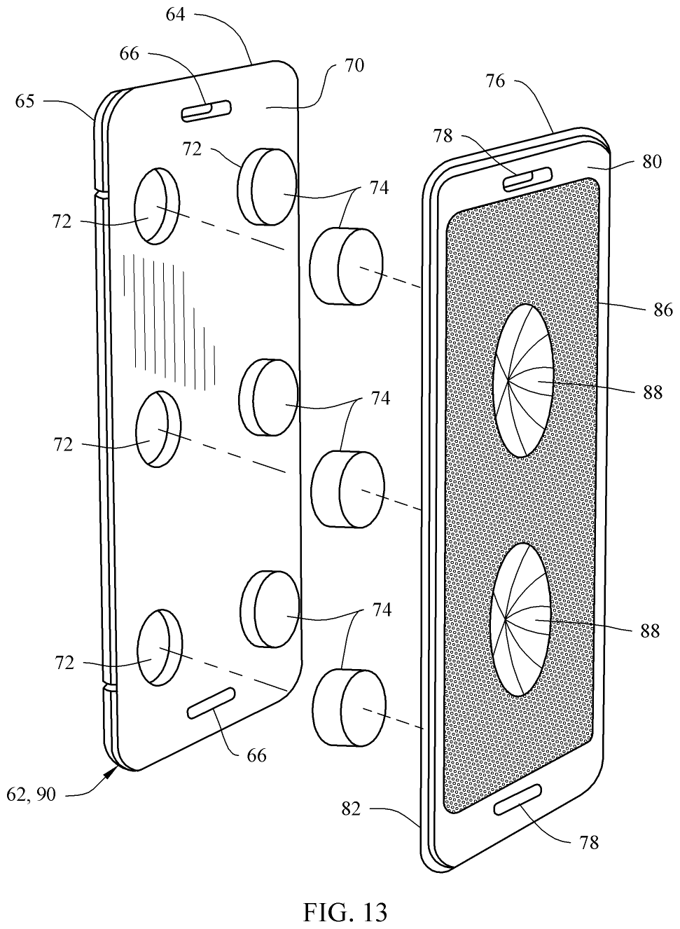

Referring now to FIG. 13, the second contact side 80 or the nano-suction section 86 can include on or more suction cups 88 molded, attached or integrated therein. The suction cups 88 can be utilized to provide a suction or adhesion force to the surface S, in addition to or separate from the suction force of the nano-suction section 86. In the exemplary, the suction cups 88 can be surrounded by the nano-suction material 86, thereby providing increased suction when additional application force is applied to the cover clamp 62, 90 toward the surface. The suction cups 88 can be made of nano-suction material, thereby creating a large suction cup featuring a plurality of nano-suction cups along its interior surface that defines the cup.

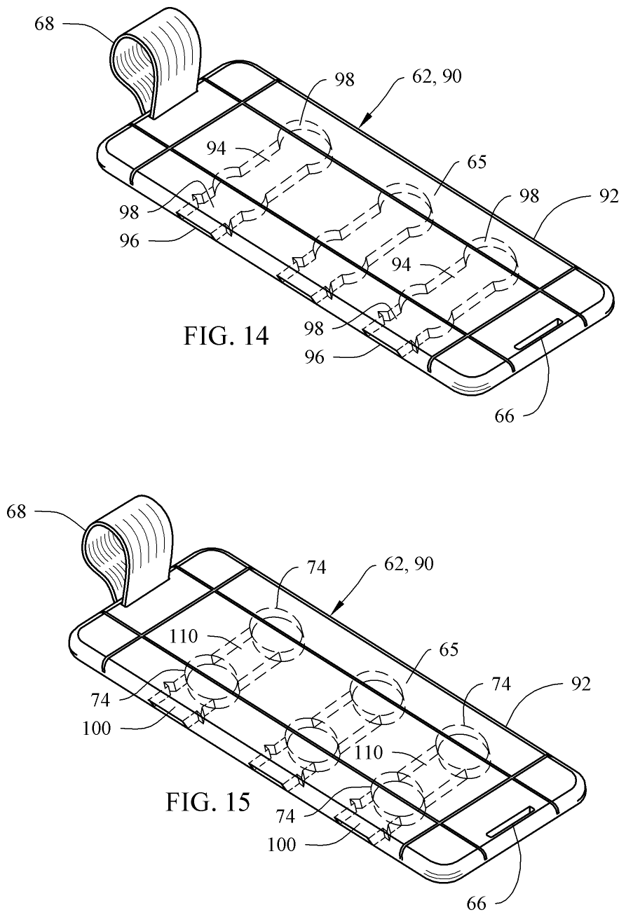

Referring to FIGS. 14-18, an embedment of the cover clamp 62, 90 is illustrated and will be described. However, it can be appreciated that any cover clamp or clamping device of the present technology can utilized the subject matter illustrated in FIGS. 14-19. The cover clamp of the present technology can be of any shape, size, material, features, type or kind, orientation, location, quantity, components, and arrangements of components that would allow the present technology to fulfill the objectives and intents of the present technology. However, it is preferred that the present technology be of material that is durable, strong, flexible, elastic, non-toxic, easily manufacturable, cost efficient, scratch-resistant, smooth, and/or lightweight. The present technology primarily can include a single encasement 92, but can include multiple encasement structures joined together to from the encasement 92. It can be preferred that the present technology be of a size such that the present technology can be held in the hands of the user and/or grasped and handled by the user. The encasement 92 can include one or more chambers 94, one or more holes 96, a plurality of magnets 74, a first plurality of segments 100, and a second plurality of segments 110.

As seen in FIGS. 14-18, the chamber 94 can be of any shape, size, material, features, type or kind, orientation, location, quantity, components, and arrangements of components that would allow the present technology to fulfill the objectives and intents of the present technology. However, it is preferred that the chamber be of a shape similar to the shape of the encasement. It is preferred that the chamber be of a size that is lesser than the size of the encasement. The chamber primarily includes a plurality of placeholders 98 that can be of any shape, size, material, features, type or kind, orientation, location, quantity, components, and arrangements of components that would allow the present technology to fulfill the objectives and intents of the present technology. However, it is preferred that the plurality of placeholders be located on the bottom face of the chamber. It is preferred that plurality of placeholders be of shape, size, and/or quantity similar to the shape, size, and/or quantity of the plurality of magnets. It is preferred that the plurality of placeholders be arranged across the bottom face of the chamber such that the plurality of magnets (when placed in the plurality of placeholders) are evenly dispersed and arranged across the bottom face of the chamber.

As seen in FIGS. 14, 15 and 18, the plurality of magnets 74 can be of any shape, size, material, features, type or kind, orientation, location, quantity, components, and arrangements of components that would allow the present technology to fulfill the objectives and intents ofthe present technology. However, it is preferred that the plurality of magnets be of shape, size, quantity, and/or arrangement similar to the shape, size, quantity, and/or arrangement of the plurality of placeholders. It can be preferred that the plurality of magnets be of a material that is magnetically attractive and/or repulsive (on either side of the plurality of magnets) while being compatible with the material of the encasement.

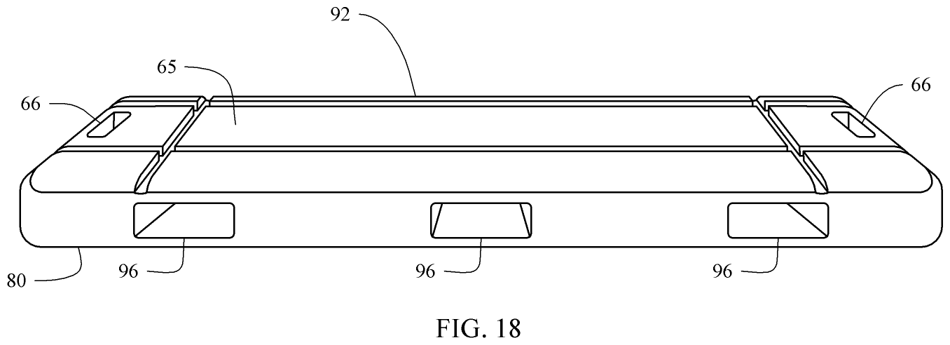

As seen in FIGS. 14, 15 and 18, the plurality of holes 96 can be of any shape, size, material, features, type or kind, orientation, location, quantity, components, and arrangements of components that would allow the present technology to fulfill the objectives and intents of the present technology. However, it is preferred that the plurality of holes be located at a side face of the encasement. It is preferred that the plurality of holes be arranged on the side face of the encasement such that the plurality of holes is aligned with the columns of the plurality of magnets, as illustrated in FIG. 18. It can be appreciated that the plurality of holes be of a quantity similar to the quantity of the columns of the plurality of magnets, as illustrated in FIG. 18. It can be appreciated that the plurality of holes be of a shape and size similar to the shape and size of the front face of the first plurality of segments, as illustrated in FIG. 15 and in FIG. 18.

As seen in FIGS. 14-18, the encasement 92 can contain a first plurality of segments 100. The first plurality of segments can be of any shape, size, material, features, type or kind, orientation, location, quantity, components, and arrangements of components that would allow the present technology to fulfill the objectives and intents of the present technology. However, it can be appreciated that the first plurality of segments be of material similar to and/or compatible with the material of the encasement. It can be appreciated that the first plurality of segments be of a quantity and arrangement similar to the quantity and arrangement of the plurality of holes. It can be appreciated that the first plurality of segments be of a height similar to the height of the plurality of holes 96. It can be appreciated that a front face of the first plurality of segments be of a shape and size similar to the shape and size of the plurality of holes. It can be appreciated that a rear face of the first plurality of segments be of a concave surface 106 similar to a front face of the plurality of magnets 74 such that the rear face of the first plurality of segments can interface with the front face of the plurality of magnets. It can be appreciated that the first plurality of segments be located between the front face of the plurality of magnets and an exterior face of the plurality of holes. The first plurality of segments can include a first fin 102 and a second fin 104.

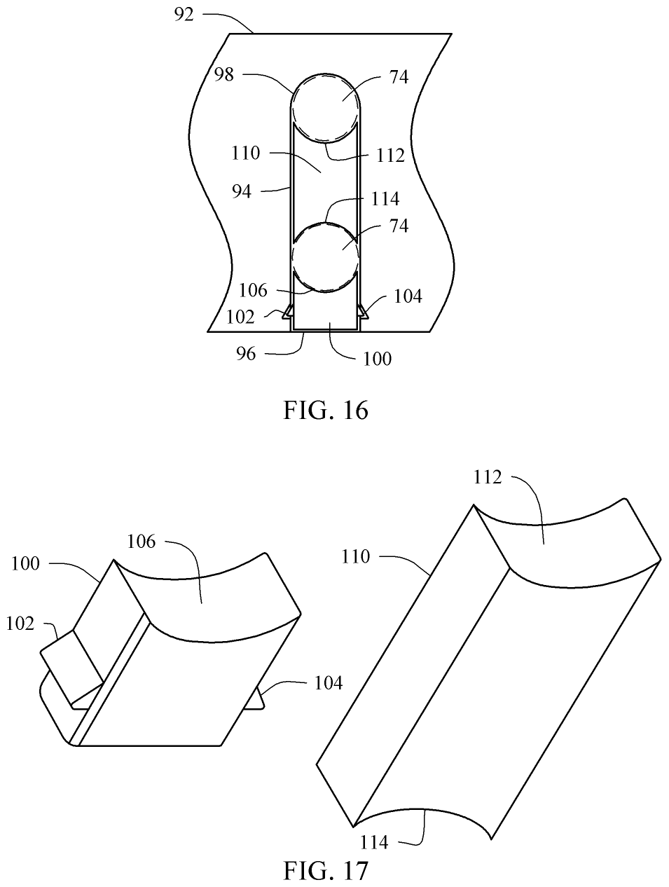

As seen in FIGS. 16-17, the first fin 102 can be of any shape, size, material, features, type or kind, orientation, location, quantity, components, and arrangements of components that would allow the present technology to fulfill the objectives and intents of the present technology. However, it can be appreciated that the first fin 102 be of material similar to the material of the first plurality of segments. It can be appreciated that the first fin be of a triangular-like shaped object. It can be appreciated that the first fin be located on a side face of the first plurality of segments near to the front face of the first plurality of segments. The second fin 104 can be of any shape, size, material, features, type or kind, orientation, location, quantity, components, and arrangements of components that would allow the present technology to fulfill the objectives and intents of the present technology. However, it can be appreciated that the second fin 104 can be identical to the first fin 102 in shape, size, material, features, type or kind, orientation, quantity, components, and arrangements of components. It can be appreciated that the second fin can be located on a side face of the first plurality of segments opposite and mirrored from the side face of the first plurality of segments containing the first fin.

The first plurality of segments 100 can be made from, but not limited to, rubber or silicon, and can be retained in the holes 96 via the first and second locking fins 102, 104 and/or utilizing an adhesive.

As seen in FIGS. 14-18, the second plurality of segments 110 can be of any shape, size, material, features, type or kind, orientation, location, quantity, components, and arrangements of components that would allow the present technology to fulfill the objectives and intents of the present technology. However, it can be appreciated that the second plurality of segments 110 can be of a material that is similar to the material of the encasement 92. It can be appreciated that the second plurality of segments 110 can be of a height that is similar to the height of the first plurality of segments 100. It can be appreciated that the second plurality of segments be of a length similar to the distance between the rear face of a row of the plurality of magnets 74 and the front face of an adjacent and/or preceding row of the plurality of magnets, as illustrated in FIG. 14. It can be appreciated that the second plurality of segments 110 can be of a width similar to the width of the first plurality of segments 100. It can be appreciated that the front face 112 of the second plurality of segments can be identical to the rear face 106 of the first plurality of segments 100. It can be appreciated that the rear face 114 of the second plurality of segments can be identical to the front face 112 of the second plurality of segments. It can be appreciated that the second plurality of segments can be located in between medial/interior surfaces of the plurality of magnets, as illustrated in FIGS. 16 and 18.

The second plurality of segments 110 can be made from, but not limited to, rubber or silicon, and can be retained in the chamber 94 utilizing an adhesive.

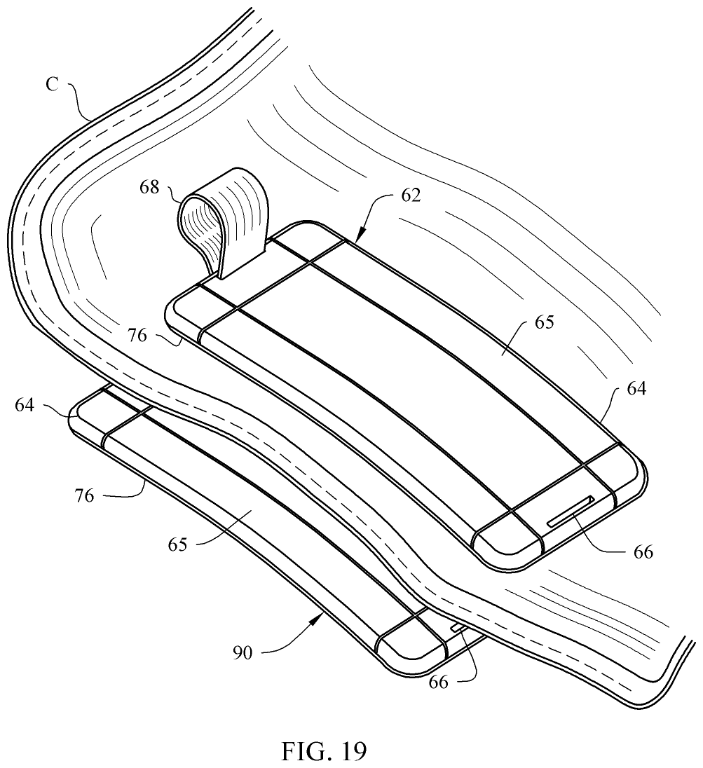

It can further be appreciated that the first cover clamp 62 and the second cover clamp 90 can clamp a portion of the cover C therebetween, resulting in a portion of the first and second cover clamps 62, 90 being in direct contact with each other. Additionally, not all of the plurality of magnets 74 of the first cover clamp 62 is required to be aligned with their corresponding magnet 74 of the second cover clamp 90 for the present technology to operate. In some cases, the first cover clamp 62 and the second cover clamp 90 can be offset with each other, as best illustrated in FIG. 19. Further, FIG. 19 shows the flexible nature of some of the embodiments of the present technology.

In some embodiments of the present technology, the encasing structures and/or encasements can be made of or include a soft resin having a high coefficient of friction, which prevents the car cover from sliding away from the cover clamp. Additionally, the encasing structures and/or encasements can comprise a plurality of rounded corners and a plurality of rounded edges. The plurality of rounded corners and the plurality of rounded edges can be externally distributed about the encasing structures and/or encasements. The plurality of rounded corners prevents the first and second encasing structures 64, 76 from scratching the painted exterior surface of the car if the encasing structures and/or encasements starts sliding on top of the exterior body surface.

In the exemplary, the encasing structures and/or encasements can be made of a high-density polymer, which allows the cover clamp to flex while retaining the original shape, as best illustrated in FIG. 11. Further in the exemplary, the thickness between the recesses/placeholders and their corresponding contact sides, can be configured to increase the effective distance between the plurality of magnets and one of the first and second contact sides, thereby moving the plurality of magnets closer to one of the first and second contact sides. As a result, the plurality of magnets are positioned closer to one of the first contact side than the second contact side, or vice versa, which causes the magnetic attraction at one of the contact side to be stronger than the magnetic attraction at the other contact side. Accordingly, the attraction force exerted by the first contact side on the exterior body surface or another cover clamp is significantly higher than attraction force exerted by the second contact side. As such, a thickly padded car cover may be used to cushion the exterior body surface against the first contact side. Accordingly, the first contact side with the relatively strong magnetic pull can be used to securely clamp a very thickly padded car cover. The second contact side having a relatively weak magnetic pull can be used to clamp a thinly padded car cover.

A plurality of cover clamps can by utilized over the entire or multiple surfaces of the vehicle, in any order, to sufficiently secure the cover to the vehicle.

In light of the above description, embodiments of the cover clamp system can be used on steel bodied surfaces, non-steel bodied surfaces, aluminum bodied surfaces as well as any object, which requires some in-between cover material to be held securely in place. The cover clamp system can be designed to house two different versions. The first version being one side or half of the encasement is a soft rubberlike material, which is the same configuration for both versions. This first half of the device being the first encasing structure, which will house a portion of the six magnets contained internally therein positioned both horizontally and vertically. This first half of the device is one half of cover clamp sandwich.

The opposite second encasing structure can be a soft and flexible half side of the second half of this cover clamp, which will also be the internal housing for the containment half of the magnets both in the same planes of horizontal and vertical configuration, which would match the opposing half. The opposite outside surface material of this half is the distinguishing difference of the two versions noted.

This second half, of the two encasements, would cover the entire outside surface with sticky nano material. This first version would offer only a favorable horizontal force to prevent any material from moving side to side. However, this configuration would not prevent vertical forces from disconnecting any material from its position from the surface of its attachment.

The second version of the opposite side would also offer flexible sticky nano material over the surface of the outside encasement. However, there can be two suction cups present. The two suction cups can also be made of the same sticky nano material. An advantage of this design would be to prevent vertical forces from disconnecting the cover clamp because of the force of suction preventing dislodgment from any surface thereon temporally attached. With this added feature, both horizontal and vertical forces would be prevented from casual dislodgment.

With either design implementation, the need for an additional magnetic device may be necessary for proper use if either of the two new nano magnetic side devices is used for attachment to non-metal objects. As a second additional magnetic device now becomes one half of a system where there is a need for an additional magnetic device as the top of a sandwich with a covering material in-between. The top magnetic device can magnetically hold the covering material in place in-between, like a sandwich with meat in-between two pieces of bread. Instead of bread, there are two magnetic cover clamp devices magnetically holding each other with the cover in-between on a non-metal surface with sticky nano-material and suctions as the securing design where magnets alone would not work on a non-steel surface.

One side of the cover clamp system can have two different versions. The first version having the sticky nano-material secured onto the entire surface on one side of the cover clamp. This nano-material will allow direct temporary adhesion to any surface and at the same time will not harm the surface it is attached to, especially non-steel bodied automobiles.

The second version can incorporate suction cups as well as the incorporated nano-sticky material to also allow the temporary adhesion to any surface, which will not harm the surface it is attached to, especially non-steel bodied automobiles. This version may allow a more secure grip to the surfaces mentioned above because of two different adhesion techniques.

Both versions of the cover clamp system can be utilized to attach to non-steel objects, and can incorporate six neodymium magnets as utilized in the embodiments of the present technology. This edification is simplified from the original concept because it does not have an internal lattice device to hold the magnets into their position as some embodiments of the present technology. The cover clamp system can be the same general size as other present embodiments and can also be flexible to allow temporary fixation to curved surfaces. The cover clamp system can also be able to affix itself to steel bodied objects using the opposite side principally because of magnets placed therein.

Although the present technology has been explained in relation to its preferred embodiment, it is to be understood that many other possible modifications and variations can be made without departing from the spirit and scope of this present technology.

While embodiments of the clamping system for car covers have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described. And although clamping a car cover onto the exterior surface of a car have been described, it should be appreciated that the clamping system of the present technology herein described is also suitable for securing any flexible or planar sheet of suitable thickness to a non-ferromagnetic or ferromagnetic surface.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A clamping system for covers comprising:
a cover clamp including one or more encasing structures providing a first contact side and a second contact side, the first contact side and the second contact side being positioned opposite to each other about the one or more encasing structures, the first contact side or the second contact side being configured to be in juxtaposition with a cover;
a nano-suction section associated with at least one of the first contact side and the second contact side, the nano-suction section being configured or configurable to adhere to a ferromagnetic surface or a non-ferromagnetic surface; and
a plurality of magnets mountable within the one or more encasing structures and distributed throughout the one or more encasing structures, the plurality of magnets being operatively integrated into the one or more encasing structures.

2. The clamping system of claim 1, wherein the one or more encasing structures is at least two encasing structures joined together.

3. The clamping system of claim 1, wherein the plurality of magnets are configured to generate a stronger magnetic pull across the first contact side and a weaker magnetic pull across the second contact side.

4. The clamping system of claim 1 further comprises a handle being detachably attached adjacent to the one or more encasing structures.

5. The clamping system of claim 1, wherein the one or more encasing structures comprises a first planar side, a second planar side, and a plurality of recesses, wherein the first planar side and the second planar side are two distinctly different sides; each of the plurality of recesses traversing through the first planar side towards the second planar side; and the plurality of recesses being distributed across the first planar side; each of the plurality of magnets being mounted into a corresponding recess from the plurality of recesses.

6. The clamping system of claim 1 further comprises a second cover clamp including one or more encasing structures providing a first contact side and a second contact side, and a plurality of magnets mountable within the one or more encasing structures of the second cover clamp.

7. The clamping system of claim 6, wherein the plurality of magnets of the cover clamp being orientated so that a magnetic attraction is created when the second contact side of the cover clamp is adjacent the first contact side of the second cover clamp.

8. The clamping system of claim 7, wherein the cover clamp and the second cover clamp are configured to clamp a cover or a portion of the cover positioned therebetween when the cover clamp and the second cover clamp are magnetically coupled to each other.

9. The clamping system of claim 1 further comprises a suction cup associated with the second contact side and in combination with the nano-suction section.

10. The clamping system of claim 1, wherein the nano-suction section is a nano-suction material integrated with or attached to the second contact side.

11. The clamping system of claim 1, wherein the one or more encasing structures is made of a soft resin.

12. The clamping system of claim 1, wherein the one or more encasing structures comprises a plurality of rounded corners and a plurality of rounded edges; and the plurality of rounded corners and the plurality of rounded edges being externally distributed about the one or more encasing structures.

13. A clamping system for covers comprising:
a first cover clamp and a second cover clamp, each comprising:
one or more encasing structures providing a first contact side and a second contact side, the first contact side and the second contact side being positioned opposite to each other about the one or more encasing structures; and
a plurality of magnets mountable within the one or more encasing structures and distributed throughout the one or more encasing structures, the plurality of magnets being operatively integrated into the one or more encasing structures;
a nano-suction section associated with the second contact side of the first cover clamp, the nano-suction section being configured or configurable to adhere to a surface; and
wherein the plurality of magnets being orientated in the second cover clamp to magnetically coupled with the plurality of magnets of the first cover clamp when the second contact side of the second cover clamp is adjacent the first contact side of the first cover clamp;
wherein the first cover clamp and the second cover clamp are configured to clamp a cover or a portion of the cover positioned therebetween when the first cover clamp and the second cover clamp are magnetically coupled to each other.

14. The clamping system of claim 13 further comprises a suction cup associated with the second contact side of the first cover clamp in combination with the nano-suction section.

15. The clamping system of claim 13, wherein the nano-suction section is a nano-suction material integrated with or attached to the second contact side of the first cover clamp.

16. The clamping system of claim 13, where each of the first cover clamp and the second cover clamp includes a handle being detachably attached adjacent to the one or more encasing structures of the first cover clamp and the second cover clamp, respectively.

17. The clamping system of claim 13, wherein the second cover clamp does not include a nano-suction section.

18. The clamping system of claim 13, wherein the plurality of magnets of at least one of the first cover clamp and the second cover clamp is configured to generate a stronger magnetic pull across the first contact side and a weaker magnetic pull across the second contact side, respectively.

19. A method of using a clamping system to hold a cover in relation to a surface, the method comprising the steps of:
a) applying a nano-suction section associated with a second contact side of a first cover clamp to a surface;
b) positioning a portion of a cover over the first cover clamp; and
c) positioning a second cover clamp adjacent the first cover clamp so that the cover or a portion thereof is therebetween and a plurality of magnets of the first cover clamp and a plurality of magnets of the second cover clamp are magnetically attracted to each other.
